(19) United States
(12) Patent Application Publication
(10) Pub. No.: US 2015/0332079 A1
(43) Pub. Date: Nov. 19, 2015

(54) APPARATUS AND METHOD FOR RECOGNIZING QUICK RESPONSE CODE

(71) Applicant: AJOU UNIVERSITY INDUSTRY-ACADEMIC COOPERATION FOUNDATION, Suwon-si, Gyeonggi-do (KR)

(72) Inventors: Woo Guil PARK, Seoul (KR); Young June CHOI, Suwon-si (KR)

(21) Appl. No.: 14/758,090

(22) PCT Filed: Dec. 30, 2013
(86) PCT No.: PCT/KR2013/012374

§ 371 Date: Jun. 26, 2015

(30) Foreign Application Priority Data
Dec. 31, 2012 (KR) 10-2012-0158136

(51) Int. Cl. G06K 7/14; G06F 17/30

(52) U.S. Cl. CPC G06K 7/1456; G06F 17/30879; G06K 7/1417; G06K 7/1443

(57) ABSTRACT

The present invention relates to an apparatus and method for recognizing a QR code and, more particularly, to QR code recognition technology that is capable of acquiring not only primary information but also additional information about a user's context or a user from a conventional QR code and then providing user customized information, and information provision technology using the same. For this purpose, an apparatus for recognizing a QR code in accordance with an embodiment of the present invention includes a QR code recognition unit, a first information extraction unit, and a second information extraction unit. The QR code recognition unit acquires data including a QR code. The first information extraction unit extracts first information stored in the QR code by decoding the acquired data. The second information extraction unit extracts second information, including relative direction information between the QR code and the QR code recognition unit, from the acquired data.

### TECHNICAL FIELD

The present invention relates to an apparatus and method for recognizing a Quick Response (QR) code and, more particularly, to QR code recognition technology that is capable of acquiring not only primary information but also additional information about a user's context or a user from a conventional QR code and then providing user customized information, and information provision technology using the same.

### BACKGROUND ART

With the spread of smart phones equipped with cameras, camera means that are carried by users have been popularized. Accordingly, various types of technology and means using cameras provided in smart phones have been also activated. These include Quick Response (QR) codes that are capable of transferring information via a two-dimensional (2D) image composed of patterns.

QR codes are codes composed of lattice 2D patterns that can represent larger amounts of information than barcodes that have been widely used in the past. QR codes are configured to enable information to be easily recognized via means capable of photographing images and then processing the information of the photographed images (for example, a smart phone). While a conventional one-dimensional barcode can only store numerical information consisting of approximately 20 numerals, a QR code can store letters ranging tens of letters to about 1800 letters. This stored information can be obtained by decoding the QR code using a QR reader, such as a smart phone. QR codes are widely used as a means of marketing or promotion because it has the advantages of being favorable for the storage of character-type data, such as alphabetical letters or numerals, and providing desirable recognition speed, recognition rate and recovery capability compared to general barcodes.

Recently, QR codes have been attached to or printed on the covers of books and have been distributed in order to allow information about the books to be retrieved. Furthermore, QR codes have been printed on the dishes of conveyor-belt sushi restaurants, or have been easily found on streets. Accordingly, QR codes can be used for managing information required in general daily life, i.e., business cards, telephone numbers, short messages, webpage URLs, etc.

As an example, Korean Patent Application Publication No. 10-2010-0085887 entitled “Forest Path Guidance System and Method Using QR Codes” discloses a technology for allowing the QR codes of signboards installed along a forest path to be decoded via a smart phone and providing various types of information over a wireless communication network, thereby guiding a user through the forest path.

As another example, Korean Patent Application Publication No. 10-2012-0117056 entitled “Information Provision System and Method Using QR Codes” discloses a technology for including QR codes in information boards installed in a terminal, a tourist spot, a public office, a train station, a museum, an exhibit hall, an apartment complex, a park, a shopping district complex, etc. and providing information about corresponding areas, apartments, shopping districts, cultural assets and departments and information about transportation and special local products online.

However, QR code-based services based on the conventional technologies are provided in a fragmentary form in which a single piece of content or information is provided for a single QR code. As an example, a QR code may be configured such that the address of a different web server or the like is basically stored in a QR code and a webpage is opened upon searching for the QR code search and shows various types of data, in which case a limitation arises in that all users who recognize the same QR code receive the same information. In particular, in spite of the fact that recently QR codes have been widely used in various fields, the limitation in which all users obtain only the same information from the same QR code may be very detrimental to some fields where the use of QR codes is attempted.

For example, when information about a text or image is recorded in a QR code, the corresponding information is acquired directly from the QR code without cooperation with a server upon recognizing the QR code. As another example, when “URL” information is recorded in a QR code, related content is acquired from a website by working in conjunction with a server, i.e., accessing a website matching the URL information, upon recognizing the code. As described above, the conventional QR code-based services have a problem in that the extension of service and utilization thereof is limited because they employ fragmentary service provision methods based on one-to-one matching between content to be provided and a code.

### DISCLOSURE

### Technical Problem

An object of the present invention is to eliminate a limitation in which all users who attempt to recognize the same QR code via their QR readers receive the same information.

Another object of the present invention is to solve a problem in which the extension of service and utilization is limited because the conventional QR code-based services employ fragmentary service provision methods based on one-to-one matching between content to be provided and a code.

Still another object of the present invention is to obtain additional information and then provide different information in accordance with a user with respect to the same QR code, in addition to utilizing information obtained by decoding a conventional QR code.

Still another object of the present invention is to provide information customized for each user, which cannot be provided by conventional QR codes.

Yet another object of the present invention is to considerably increase the range of usage and function of conventional QR codes, unlike in a method of decoding information encoded in a conventional QR code and then providing the decoded information, thereby providing various services, which cannot have been supported in the past.

### Technical Solution

In order to accomplish at least one of the above objects, in accordance with an embodiment of the present invention, there is provided an apparatus for recognizing a QR code including a QR code recognition unit, a first information extraction unit, and a second information extraction unit. The QR code recognition unit acquires data including a QR code. The first information extraction unit extracts first information stored in the QR code by decoding the acquired data. The second information extraction unit extracts second information, including relative direction information between the QR code and the QR code recognition unit, from the acquired data.

In this case, the relative direction information between the QR code and the QR code recognition unit may be represented using a normal vector and a direction vector. The normal vector may correspond to an angle that is formed by a plane including the QR code and a plane including a camera sensor of the QR code recognition unit. The direction vector may correspond to a direction in which the QR code is located on the plane including the QR code.

In accordance with an embodiment of the present invention, the first information may include a plurality of pieces of data to be provided in accordance with the relative direction information. In this case, the apparatus for recognizing a QR code may further include a decoding data generation unit configured to select at least part of the plurality of pieces of data included in the first information by using the second information as a condition of selection and then generate the selected data as decoding data.

In accordance with another embodiment of the present invention, a different type of decoding data generation unit may be implemented. In this case, the decoding data generation unit may generate decoding data, in which first information and second information are embedded, by including the basic first information and the second information indicative of relative direction information in a QR code.

In accordance with an embodiment of the present invention, there is provided a method of recognizing a QR code, including (a) acquiring data including a QR code; (b) extracting first information stored in the QR code by decoding the acquired data; and (c) extracting second information, including relative direction information between the QR code and a QR code recognition unit, from the acquired data.

### Advantageous Effects

As described above, in accordance with the present invention, while the conventional QR code uses a method of using only information obtained through decoding, the present invention additionally obtains information about the relative direction between a QR code and the QR code recognition unit, and provides different information in accordance with the obtained information even in the case of the same QR code, thereby achieving the effect of providing user-customized information based on the height or direction of a user, which cannot be provided by the conventional QR code.

In accordance with the present invention, an adult and a child can be distinguished based on the height of a user and then suitable information can be provided, a direction in which a user is moving or a direction in which a user is standing can be determined and then suitable information can be provided, and an environment in which QR codes can be utilized in a user interactive manner can be provided (in a game, etc.).

That is, unlike the method in which a conventional QR code provides the same information to all users simply using contained data, the present invention additionally obtains the relative direction information between a QR code and a user through calculation, and provides different information based on the relative direction information, thereby considerably improving the range of usage and function of conventional QR codes. For example, QR codes are widely used in advertising. When the present invention is applied to advertising, information about the height of a user can be obtained, and thus the effect of an advertisement can be further increased by introducing products appropriate for the height of the user via the advertisement of clothes.

### DESCRIPTION OF DRAWINGS

FIG. 1 is a diagram showing the schematic configuration of an apparatus for recognizing a QR code in accordance with the present invention;

FIG. 2 is a diagram showing a conventional QR code;

FIG. 3 is a diagram showing a process of obtaining a normal vector and a direction vector in accordance with the present invention;

FIG. 4 is a diagram showing the location of information included in a QR code;

FIG. 5a is a diagram showing a process of providing different information in accordance with height;

FIG. 5b is a diagram showing a process of providing different geographical information in accordance with direction;

FIG. 5c is a diagram showing a process of automatically controlling a vehicle based on location information;

FIG. 5d is a diagram showing a process of playing a game using direction information; and

FIG. 6 is a diagram showing the schematic flow of a method of recognizing a QR code in accordance with an embodiment of the present invention.

### BEST MODE

In order to accomplish at least one of the above objects, in accordance with an embodiment of the present invention, there is provided an apparatus for recognizing a QR code including a QR code recognition unit, a first information extraction unit, and a second information extraction unit. The QR code recognition unit acquires data including a QR code. The first information extraction unit extracts first information stored in the QR code by decoding the acquired data. The second information extraction unit extracts second information, including relative direction information between the QR code and the QR code recognition unit, from the acquired data.

In this case, the relative direction information between the QR code and the QR code recognition unit may be represented using a normal vector and a direction vector. The normal vector may correspond to an angle that is formed by a plane including the QR code and a plane including a camera sensor of the QR code recognition unit. The direction vector may correspond to a direction in which the QR code is located on the plane including the QR code.

In accordance with an embodiment of the present invention, the first information may include a plurality of pieces of data to be provided in accordance with the relative direction information. In this case, the apparatus for recognizing a QR code may further include a decoding data generation unit configured to select at least part of the plurality of pieces of data included in the first information by using the second information as a condition of selection and then generate the selected data as decoding data.

In accordance with another embodiment of the present invention, a different type of decoding data generation unit may be implemented. In this case, the decoding data generation unit may generate decoding data, in which first information and second information are embedded, by including the basic first information and the second information indicative of relative direction information in a QR code.

In accordance with an embodiment of the present invention, there is provided a method of recognizing a QR code, including (a) acquiring data including a QR code; (b) extracting first information stored in the QR code by decoding the acquired data; and (c) extracting second information, including relative direction information between the QR code and a QR code recognition unit, from the acquired data.

### MODE FOR INVENTION

Preferred embodiments of the present invention will be described in detail below with reference to the accompanying drawings. In the following description of the present invention, if it is determined that detailed descriptions of related well-known configurations or functions may make the gist of the present invention obvious, the detailed descriptions will be omitted. Furthermore, in the descriptions of embodiments of the present invention, specific numerical values correspond merely to embodiments, and exaggerated numerical values different from actual numerical values may be presented for ease of description and understanding.

<Description of Apparatus>

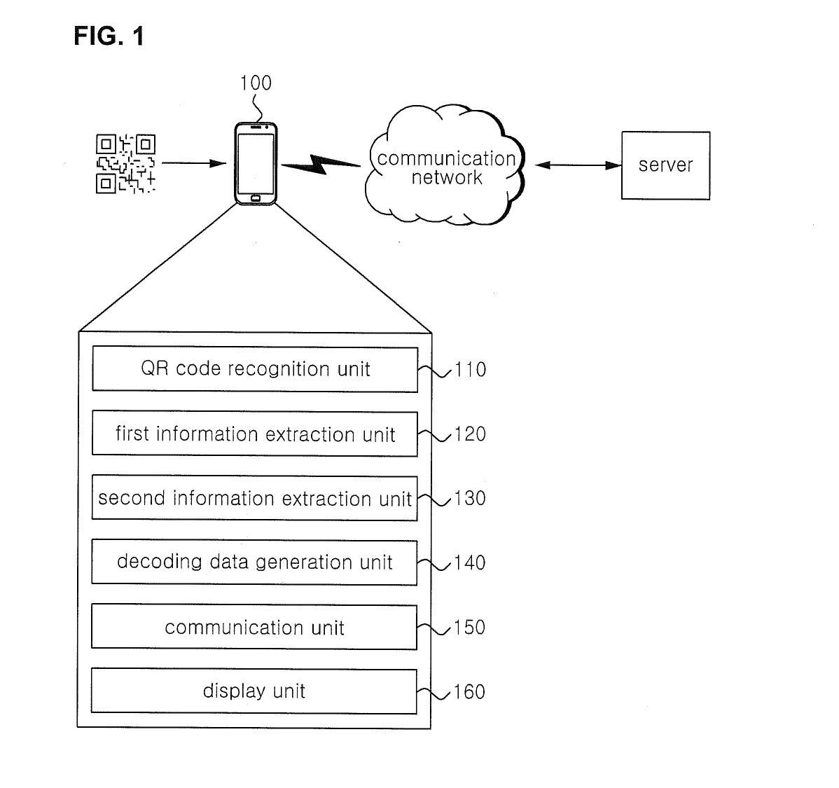

FIG. 1 is a diagram showing the schematic configuration of an apparatus for recognizing QR code in accordance with the present invention.

Referring to FIG. 1, an apparatus 100 for recognizing QR code in accordance with the present invention includes a QR code recognition unit 110, a first information extraction unit 120, a second information extraction unit 130, a decoding data generation unit 140, a communication unit 150, and a display unit 160.

In this case, the apparatus 100 for recognizing QR code may be equipped with a QR code recognition application and applied in the form of a smart phone carried by a user, may be applied to a computer apparatus on which QR code recognition software has been installed and which has been connected to the Internet, and may be applied to a separate dedicated apparatus for recognizing QR code. The present invention is limited to these configurations. The apparatus 100 for recognizing QR code may include a camera module or optical scan module that is capable of external QR code.

The QR code recognition unit 110 acquires data including a QR code. In an embodiment, the QR code recognition unit 110 converts a surrounding image, including a QR code acquired via a camera module, into a pixel-based gray scale image, converts the gray scale image into a histogram indicative of distribution based on the brightness of each pixel, extracts only pixels, the brightness value concentration levels of which are each equal to or higher than a threshold value, based on the histogram, sets the extracted pixels as a candidate pixel group, searches for points of recognition in the set candidate pixel group via a recognition marker, and recognizes the QR code if three points of recognition are found.

The first information extraction unit 120 extracts first information stored in the QR code by decoding the data acquired from the QR code. In this case, the first information may be based on a concept similar to that of conventional information that is stored in a conventional QR code and transferred to a user terminal. However, in accordance with various embodiments of the present invention, the first information may not necessarily correspond to information stored in a conventional QR code. For example, in accordance with a condition-based scheme corresponding to an embodiment of the present invention, the first information includes a plurality of pieces of data that may be provided in accordance with relative direction information between the QR code and the QR code recognition unit 110, and is thus differentiated from info/notion stored in a conventional QR code.

In accordance with the embedding scheme corresponding to another embodiment of the present invention, the first information includes one of the pieces of online link information of a blog, a cafe and a website that provide personal information, company information, tourism information, movie information, etc., like that of a conventional QR code. These schemes are described in detail below.

The second information extraction unit 130 extracts second information, including the relative direction information between the QR code and the QR code recognition unit 110, from the acquired data. The second information is information that is extracted in order to provide different information in accordance with the relative direction information so that the range of usage and function of conventional QR code can be significantly improved. Of the above-described information, the relative direction information between the QR code and the QR code recognition unit 110 refers to information about the angle between the QR code and a user carrying the apparatus 100 for recognizing QR code, i.e., information that enables the location of the user to be determined based on the QR code. The relative direction information is represented using a normal vector and a direction vector.

The normal vector corresponds to an angle formed by a plane including the QR code and a plane including the camera sensor of the QR code recognition unit 110, and the direction vector corresponds to a direction in which the QR code is located on the plane including the QR code. A method of obtaining the vectors is now described.

First, the method of obtaining the direction vector and normal vector of a QR code is described.

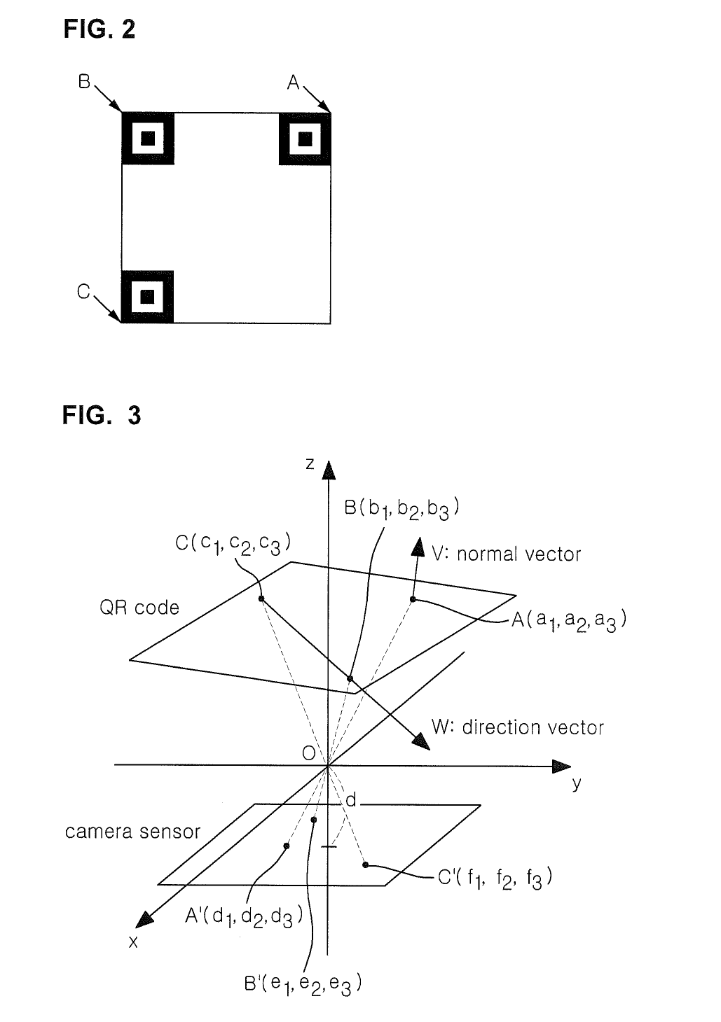

Assuming that the corners of the three position detection pattern of the QR code are denoted by A, B and C, respectively, as shown in FIG. 2, the length of the two vectors is |\vec{AB}|=|\vec{BC}| and ∠ABC=90° in accordance with the characteristics of the QR code, and thus the inner product of the two vectors is \vec{AB}·\vec{BC}=0.

As shown in FIG. 2, the direction in which the QR code is disposed on the plane to which the QR code belongs may be represented using the corners A, B and C. Since the relationships between the corners A, B and C have been already agreed by the recognition apparatus 100, the direction vector may be determined only if the corners of the corners A, B and C that will be selected as reference locations are determined. For example, if the corners B and C have been selected as the reference locations, the direction vector of the QR code may be represented using a vector between the corners B and C. However, since the QR code recognition unit 110 can obtain a direction vector by analyzing acquired optical or image data, this process is described in detail below.

Now, consider the situation in which the QR code recognition unit 110, i.e., the camera, takes a photo in order to recognize a QR code in 3D space, as shown in FIG. 3. The three points A, B and C of the QR code correspond to points A′, B′ and C′ of an image taken by the camera sensor. That is, A, B and C are points corresponding to respective corners of the QR code, and are (a₁, a₂, a₃), (b₁, b₂, b₃), and (c₁, c₂, c₃), respectively. A′, B′ and C′ are points in the image, taken by the camera sensor of the QR code recognition unit 110, corresponding to A, B and C, and are (d₁, d₂, d₃), (f₁, f₂, f₃), and (e₁, e₂, e₃), respectively. In this case, assume that the camera sensor is spaced apart from a lens by “d,” the z axis passes through the center of the camera sensor or image for the sake of convenience, and the size of the camera sensor is known. In this case, “d” is a variable whose actual value does not need to be determined and which is used only for description. Since rectilinear lines \vec{AA′}, \vec{BB′}, and \vec{CC′} all pass through an origin O and the camera sensor and the origin are spaced apart by “d,” Equation 1 below is satisfied:

$$\begin{matrix}\vec{{OA}^{′}} = ( {d}_{1} , {d}_{2} , {d}_{3} ) = ( {d}_{1} , {d}_{2} , - d ) = - \frac{d}{{a}_{3}} ( {a}_{1} , {a}_{2} , {a}_{3} ) = - \frac{d}{{a}_{3}} \vec{OA} & ( 1 ) \\ \vec{{OB}^{′}} = ( {e}_{1} , {e}_{2} , {e}_{3} ) = ( {e}_{1} , {e}_{2} , - d ) = - \frac{d}{{b}_{3}} ( {b}_{1} , {b}_{2} , {b}_{3} ) = - \frac{d}{{b}_{3}} \vec{OB} & \\ \vec{{OC}^{′}} = ( {f}_{1} , {f}_{2} , {f}_{3} ) = ( {f}_{1} , {f}_{2} , - d ) = - \frac{d}{{c}_{3}} ( {c}_{1} , {c}_{2} , {c}_{3} ) = - \frac{d}{{c}_{3}} \vec{OC} & \\ When Equation 1 is modified , & \\ \vec{OA} = - \frac{{a}_{3}}{d} \vec{{OA}^{′}} & \\ \vec{OB} = - \frac{{b}_{3}}{d} \vec{{OB}^{′}} & \\ \vec{OC} = - \frac{{c}_{3}}{d} \vec{{OC}^{′}} & \end{matrix}$$

Now, Equation 2 below is formulated from the characteristics of the three position detection pattern of the QR code:

$$\vec{AB} \cdot \vec{BC} = ( \vec{OB} - \vec{OA} ) \cdot ( \vec{OC} - \vec{OB} ) = ( \frac{{a}_{3}}{d} \vec{{OA}^{′}} - \frac{{b}_{3}}{d} \vec{{OB}^{′}} ) \cdot ( \frac{{b}_{3}}{d} \vec{{OB}^{′}} - \frac{{c}_{3}}{d} \vec{{OC}^{′}} ) = 0 ⇒ ( {a}_{3} \vec{{OA}^{′}} - {b}_{3} \vec{{OB}^{′}} ) \cdot ( {a}_{3} \vec{{OB}^{′}} - {c}_{3} \vec{{OC}^{′}} ) = 0 \qquad ( 2 )$$

In this case, the condition

$$α = \frac{{a}_{3}}{{b}_{3}} , β = \frac{{c}_{3}}{{b}_{3}} , {b}_{3} \neq 0$$

is given.

Based on the characteristics of the three points A′, B′ and C′, Equation 3 below is formulated:

$$( α \vec{{OA}^{′}} - \vec{{OB}^{′}} ) \cdot ( \vec{{OB}^{′}} - β \vec{{OC}^{′}} ) = 0 ⇔ ( α {d}_{1} - {e}_{1} , α {d}_{2} - {e}_{2} , α {d}_{3} - {e}_{3} ) \cdot ( {e}_{1} - β {f}_{1} , {e}_{2} - β {f}_{2} , {e}_{3} - β {f}_{3} ) = ( α {d}_{1} - {e}_{1} ) ( {e}_{1} - β {f}_{1} ) + ( α {d}_{2} - {e}_{2} ) ( {e}_{2} - β {f}_{2} ) + ( α {d}_{3} - {e}_{3} ) ( {e}_{3} - β {f}_{3} ) = α ( {d}_{1} {e}_{1} + {d}_{2} {e}_{2} + {d}_{3} {e}_{3} ) - αβ ( {d}_{1} {f}_{1} + {d}_{2} {f}_{2} + {d}_{3} {f}_{3} ) + β ( {e}_{1} {f}_{1} + {e}_{2} {f}_{2} + {e}_{3} {f}_{3} ) - ( {e}_{1}^{2} + {e}_{2}^{2} + {e}_{3}^{2} ) = α P - αβ Q + β R - S = 0 , P = {d}_{1} {e}_{1} + {d}_{2} {e}_{2} + {d}_{3} {e}_{3} , Q = {d}_{1} {f}_{1} + {d}_{2} {f}_{2} + {d}_{3} {f}_{3} , R = {e}_{1} {f}_{1} + {e}_{2} {f}_{2} + {e}_{3} {f}_{3} , S = {e}_{1}^{2} + {e}_{2}^{2} + {e}_{3}^{2} \qquad ( 3 )$$

Furthermore, Equation 4 below is formulated:

$$\vert \vec{AB} \vert = \vert \vec{BC} \vert ⇔ \vert {a}_{3} \vec{{OA}^{′}} - {b}_{3} \vec{{OB}^{′}} \vert = \vert {b}_{3} \vec{{OB}^{′}} - {c}_{3} \vec{{OC}^{\to }} \vert ⇔ \vert α \vec{{OA}^{′}} - {b}_{3} \vec{{OB}^{′}} \vert = \vert \vec{{OB}^{′}} - β \vec{{OC}^{′}} \vert ⇒ {\vert α \vec{{OA}^{′}} - {b}_{3} \vec{{OB}^{′}} \vert}^{2} = {\vert \vec{{OB}^{′}} - β \vec{{OC}^{′}} \vert}^{2} ⇒ {( α {d}_{1} - {e}_{1} )}^{2} + {( α {d}_{2} - {e}_{2} )}^{2} + {( α {d}_{3} - {e}_{3} )}^{2} = {( {e}_{1} - β {f}_{1} )}^{2} + {( {e}_{2} - β {f}_{2} )}^{2} + {( {e}_{3} - β {f}_{3} )}^{2} ⇒ {α}^{2} ( {d}_{1}^{2} + {d}_{2}^{2} + {d}_{3}^{2} ) - 2 α ( {d}_{1} {e}_{1} + {d}_{2} {e}_{2} + {d}_{3} {e}_{3} ) - {β}^{2} ( {f}_{1}^{2} + {f}_{2}^{2} + {f}_{3}^{2} ) - 2 β ( {e}_{1} {f}_{1} + {e}_{2} {f}_{2} + {e}_{3} {f}_{3} ) = 0 ⇒ {α}^{2} T - 2 α P - {β}^{2} U + 2 β R = 0 , T = {d}_{1}^{2} + {d}_{2}^{2} + {d}_{3}^{2} , U = {f}_{1}^{2} + {f}_{2}^{2} + {f}_{3}^{2} \qquad ( 4 )$$

Therefore, α and β are obtained by Equations 3 and 4.

Now, the normal vector \vec{V} on the QR code plane may be obtained by \vec{AC}×\vec{AB}.

Since a₃b₃=α:β:1, a solution is obtained by Equation 5 below:

$$( \vec{OC} - \vec{OA} ) \times ( \vec{OB} - \vec{OA} ) = ( ( \frac{- {c}_{3}}{d} ) \vec{{OC}^{′}} - ( \frac{- {a}_{3}}{d} ) \vec{{OA}^{′}} ) \times ( ( \frac{- {b}_{3}}{d} ) \vec{{OB}^{′}} - ( \frac{- {a}_{3}}{d} ) \vec{{OA}^{′}} ) = \frac{{b}_{3}}{d} ( β \vec{{OC}^{′}} - α \vec{{OA}^{′}} ) \times ( \vec{{OB}^{′}} - α \vec{{OA}^{′}} ) \qquad ( 5 )$$

Therefore, the unit normal vector may be expressed by Equation 6 below:

$$\vec{V} = \frac{( \vec{OC} - \vec{OA} ) \times ( \vec{OB} - \vec{OA} )}{\vert ( \vec{OC} - \vec{OA} ) \times ( \vec{OB} - \vec{OA} ) \vert} = \frac{( β \vec{{OC}^{′}} - α \vec{{OA}^{′}} ) \times ( \vec{{OB}^{′}} - α \vec{{OA}^{′}} )}{\vert ( β \vec{{OC}^{′}} - α \vec{{OA}^{′}} ) \times ( \vec{{OB}^{′}} - α \vec{{OA}^{′}} ) \vert} \qquad ( 6 )$$

Furthermore, the following relationships are derived:

$$\vec{CB} = \vec{OB} - \vec{OC} = - \frac{{b}_{3}}{d} \vec{{OB}^{′}} + \frac{{c}_{3}}{d} \vec{{OC}^{′}} = \frac{{b}_{3}}{d} ( \frac{{c}_{3}}{{b}_{3}} \vec{{OC}^{′}} - \vec{{OB}^{′}} ) = \frac{{b}_{3}}{d} ( β \vec{{OC}^{′}} - \vec{{OB}^{′}} )$$

Therefore, a unit direction vector may be expressed by Equation 7 below:

$$\vec{W} = \frac{\vec{CB}}{\vert \vec{CB} \vert} = \frac{β \vec{{OC}^{′}} - \vec{{OB}^{′}}}{\vert β \vec{{OC}^{′}} - \vec{{OB}^{′}} \vert} \qquad ( 7 )$$

As described above, using \vec{V} and \vec{W}, a direction in which the QR code is inclined with respect to the apparatus 100 for recognizing QR code in 3D space may be determined. However, in order to calculate this, a heavy computational load is required. Accordingly, when high accuracy is not required and also the component of a normal vector with respect to a specific plane is required, it is advantageous to approximately obtain the vectors rather than directly obtaining V and W.

Accordingly, the second information extraction unit 130 in accordance with the present invention may approximate a normal vector and a direction vector.

For example, Equation 8 below may be used:

$$\vec{W} = \frac{β \vec{{OC}^{′}} - \vec{{OB}^{′}}}{\vert β \vec{ {OC}^{′}} - \vec{{OB}^{′}} \vert} ∼ \frac{\vec{{B}^{′} {C}^{′}}}{\vert \vec{{B}^{′} {C}^{′}} \vert} , β \sim 1 \qquad ( 8 )$$

In this case, on the assumption that the QR code is located in proximity to the center of a screen, the normal vector component \vec{V}_{xz} of the normal vector on the x-z plane may be approximated by Equation 9 below:

$$\vec{{V}_{xz}} = \frac{{( \vec{{OA}^{′}} + \vec{{OB}^{′}} )}_{xz}}{\vert {( \vec{{OA}^{′}} + \vec{{OB}^{′}} )}_{xz} \vert} \qquad ( 9 )$$

In the same manner, the normal vector component \vec{V}_{yz} of the normal vector on the y-z plane may be approximated by Equation 10 below:

$$\vec{{V}_{yz}} = \frac{{( \vec{{OA}^{′}} + \vec{{OC}^{′}} )}_{yz}}{\vert {( \vec{{OA}^{′}} + \vec{{OC}^{′}} )}_{yz} \vert} \qquad ( 10 )$$

In this case, \vec{X}ᵢⱼ refers to a vector including only components of vector \vec{X} on the i−j plane.

As described above, the present invention mainly provides two embodiments as a method of providing data based on the relative direction information between the QR code a calculated and the apparatus 100 for recognizing QR code, which is calculated as described above. These two embodiments are described below.

First, as an embodiment of the present invention, a condition-based scheme is a method of obtaining corresponding information based on the condition of relative direction information. In this method, conditional equations (conditions of selection) have been given to pieces of relative direction information, and a plurality of pieces of data that should be provided in accordance with the conditional equations is present. A single piece of data is present in accordance with each conditional equation, and data meeting this condition is finally selected. That is, in QR code based on the condition-based scheme, different pieces of data that are provided for respective pieces of direction information (respective conditions of selection) have been defined.

Next, as another embodiment of the present invention, an embedding scheme is a method of obtaining relative direction information in the state in which the relative direction information is included in decoding data itself. Calculated relative direction information is provided to a server. For example, in the embedding scheme, a single piece of result provision information, such as online link information, is included in a QR code.

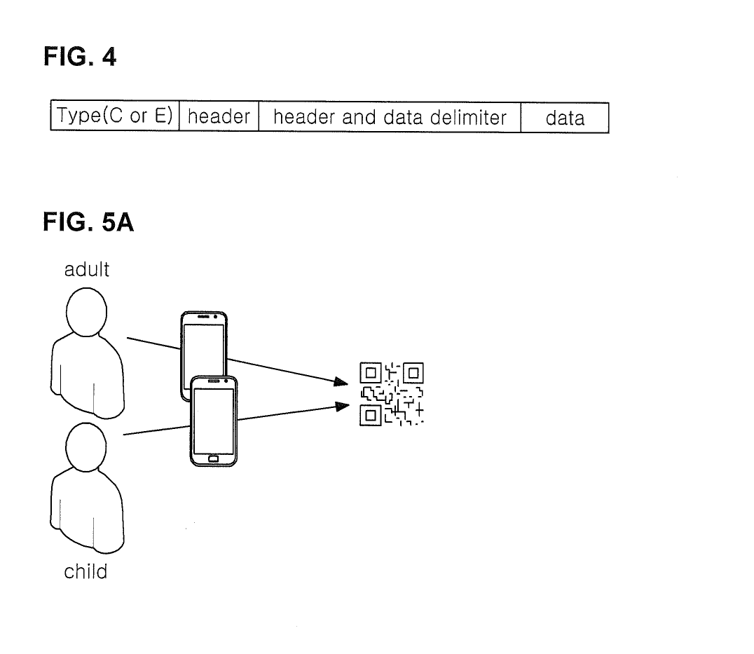

Relative direction information, a condition, and information about a location where embedment will be performed are included in a header located in front of conventional QR code information, as shown in FIG. 4. The header and the data are distinguished by delimiter “:”. When the first letter of the header is C, it indicates that header information has been configured based on the condition-based scheme; when the first letter of the header is E, it indicates that header information has been configured based on the embedding scheme.

The functions of the decoding data generation unit 140 are described in connection with the above-described condition-based scheme and embedding scheme are described below.

In connection with the condition-based scheme, first information includes a plurality of pieces of data that will be provided in accordance with relative direction information. For example, a QR code includes online link information for each piece of relative direction information. The decoding data generation unit 140 selects at least part of the plurality of pieces of data, included in the first information, using the second information as a condition of selection, and generates the selected data as decoding data. That is, the decoding data generation unit 140 generates decoding data based on data matching the relative direction information between the QR code and the QR code recognition unit 110, which is extracted by the second information extraction unit 130, among data to be provided in accordance with the relative direction information, i.e., the first information extracted from the QR code by the first information extraction unit 120. The condition of selection is expressed in the form of a general equation, and is present in parallel in the header. Pieces of data corresponding to respective conditional equations are present in parallel in the data. Fields and symbols used in this method are listed in the following table:

TABLE 1

| | Symbol in QR | |
|---|---|---|
| Field | code | Description |
| Condition | C | indicative of condition-based scheme |
| | | calculate at high precision. When |
| High precision | H | there is no H, approximate |
| | | calculation is performed. |
| \vec{X}ᵢ | Xi | vector component of vector X on i |
| | | plane |
| Conditional | >, <, ==, >=, | position in QR code data where |
| equation | <=, [0-9]+, OR, | information should be located |
| | AND, = | |
| Position | [0-9]+, [0-9]+ | If conditional equation is true, |
| | | location of data (start and end) to |
| | | be obtained |

For example, assume that decoding data is as follows:

CVx<0=1,4x==0=5,10x>0=11,15:LEFTCENTERRIGHT

In accordance with the condition of the x coordinate value of a direction vector:

if x<0, LEFT, i.e., the 1st to 4th letters of the data field, are selected and form final decoding data;

if x=0, CENTER, i.e., the 5th to 10th letters of the data field, are selected and form final decoding data; and

if x>0, RIGHT, i.e., the list to 15th letters of the data field, are selected and form final decoding data.

In connection with the embedding scheme, the decoding data generation unit 140 generates decoding data including first information and second information. In other words, the decoding data generation unit 140 generates decoding data based on online link information, i.e., the first information extracted from the QR code by the first information extraction unit 120 and the relative direction information between the QR code and the QR code recognition unit 110, which is extracted by the second information extraction unit 130. Fields and symbols used in this method are listed in the following table:

TABLE 2

| | Symbol in QR | |
|---|---|---|
| Field | code | Description |
| Embedding | E | indicative of embedding scheme |
| | | calculate at high precision. When |
| High precision | H | there is no H, approximate |
| | | calculation is performed. |
| \vec{X} | X | vector X |
| \vec{X}ᵢⱼ | Xij | vector component of vector X on i-j |
| | | plane |
| Position | [0-9]+ | position in QR code data where |
| | | information should be located |

For example, when decoded QR code data is

EHV37Wxz43:http://www.directedqr.com?direction=&norm=, this means that a direction vector should be obtained through accurate calculation, not an approximate method, and a normal vector may be obtained using approximate method. Assume that the direction vector is (0.6, 0.8, 0) and the x-z component of the approximately obtained normal vector is (0.1, 0.3). In data, a vector is represented as only an integer part exclusive of ‘0’, such as 6 for 0.6, for convenience of parsing. That is, (0.6, 0.8, 0) is represented as 6, 8, 0. Accordingly, a result that is obtained upon final decoding is as follows”

http://www.directedqr.com?direction=6,8,0&norm=1,3

The communication unit 150 transmits decoding data, generated as described above, to a server, receives corresponding data from the server, and provides the data to a user via the display unit 160.

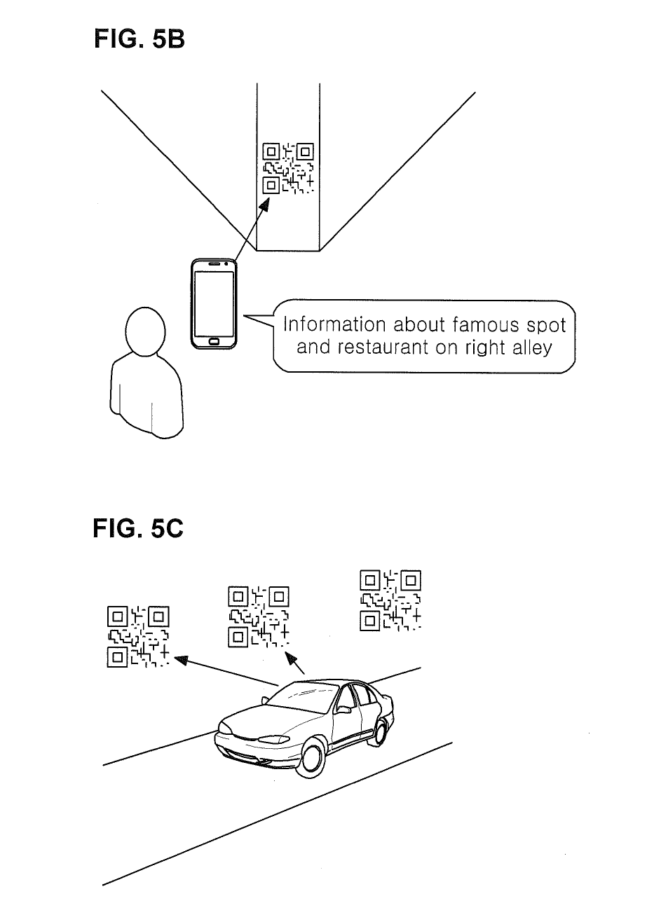

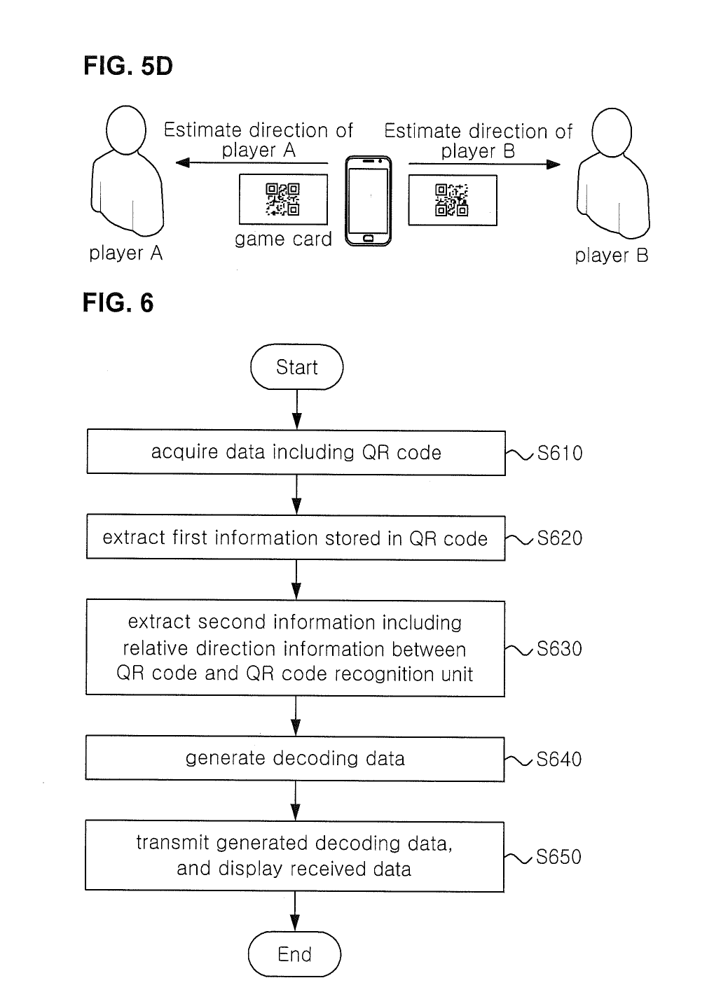

As described above, since the present invention can also obtain the directions of a QR code and a user, rather than simply obtaining data, encoded in a QR code, through decoding, the present invention can provide various services that cannot be supported by conventional QR code. In the following, various embodiments related to the provision and usage of direction information of the present invention are described using FIGS. 5a to 5d.

### Application Example 1

### Provision of Information Based on Height

First, referring to FIG. 5a, even in the case of the same QR code, the angle between the QR code and the camera of the apparatus 100 for recognizing QR code varies depending on the height of a human who recognizes the QR code. Accordingly, the height of a currently photographed human can be estimated using information about whether the distance between the QR code and the human is constant or using the size of the QR code and the angle-of-view information of the camera, and different information can be provided based on the estimated height even in the case of the same QR code. For example, customized information can be provided, as in the case where clothes suitable for a tall person is recommended to the tall person or the case where a product that makes his or her height seem taller than his or her actual height is recommended to a short person. Furthermore, in the case of a QR code intended to provide movie information, children movie information can be provided to a short person first, and adult movie information can be provided to a tall person first.

### Application Example 2

### Provision of Geographical Information Based on Direction

Referring to FIG. 5b, when a QR code for tourism information present at a tourist spot is recognized in a direction in which a user currently desires to go, a service for providing tourism information or geographical information related to the direction can be provided. Although information about directions is basically dependent on a GPS, the GPS is problematic in that it has a battery consumption problem and also error occurs in a building-populated area and an indoor area. Accordingly, the above-described geographical information provision service using QR code can be an easy and efficient solution that can overcome the above problems.

### Application Example 3

### Automatic Control Using Location Information

Referring to FIG. 5c, when there is automatically moving unmanned equipment, QR code can be used for the equipment to obtain current location information or direction. Since a current moving direction can be determined via location information encoded in a QR code and the relative direction between the QR code and the QR code recognition unit 110 obtained up recognition, the moving direction can be accurately adjusted based on the current moving direction.

### Application Example 4

### Case Using Direction Information

Although QR code has been applied to various games, the direction between a camera and a QR code and location information are not used. When direction information is additionally used, various functions and various types of amusement can be added. For example, referring to FIG. 5d, when QR codes are present in cards and also a card game in which the QR codes are recognized is present, the directions of the cards can be determined based on a camera upon recognizing the cards. Accordingly, assuming that game players who recognize the cards recognize the QR codes via the apparatus 100 for recognizing QR code while correctly holding the cards, this means that the directions of the game players can be determined, and thus the players of the cards can be determined upon recognizing the QR codes. The fact that player information can be automatically provided in a player-based game means that the structure of the game can be simplified and the game itself can be advantageously enjoyed.

As described above, while the conventional QR code uses a method of using only information obtained through decoding, the present invention additionally obtains information about the relative direction between a QR code and the QR code recognition unit 110, and provides different information in accordance with the obtained information even in the case of the same QR code, thereby achieving the effect of providing user-customized information based on the height or direction of a user, which cannot be provided by the conventional QR code.

That is, unlike the method in which the conventional QR code provides the same information to all users simply using contained data, the present invention additionally obtains the relative direction information between a QR code and a user through calculation, and provides different information based on the relative direction information, thereby considerably improving the range of usage and function of conventional QR code. For example, QR code is widely used for advertisement. When the present invention is applied to advertisement, information about the height of a user can be obtained, and thus the effect of advertisement can be further increased by introducing products appropriate for the height via the advertisement of clothes.

<Description of Method>

A method of recognizing QR code in accordance with an embodiment of the present invention is described with reference to the exemplary diagrams shown in FIGS. 1 to 5d together with the flowchart shown in FIG. 6, with sequential positions being assigned to the steps of the method for the sake of convenience.

1. Step of Obtaining Data Including QR Code <S610>

This step is a step at which the QR code recognition unit 110 acquires data including a QR code. At this step, the QR code recognition unit 110 converts a surrounding image, including a QR code, acquired via a camera module, into a pixel-based gray scale image, converts the gray scale image into a histogram indicative of distribution based on the brightness of each pixel, extracts only pixels, the brightness value concentration levels of which are each equal to or higher than a threshold value, based on the histogram, sets the extracted pixels as a candidate pixel group, searches for points of recognition in the set candidate pixel group via a recognition marker, and recognizes the QR code if three points of recognition are found.

In this case, the acquired data includes not only the information stored in the QR code itself but also the direction information between the QR code and the QR code recognition unit 110, as described above.

2. Step of Extracting First Information Stored in QR Code <S620>

The first information extraction unit 120 extracts first information stored in the QR code by decoding the data acquired at step S610. In this case, as described above, although the first information may be based on a concept similar to that of conventional information that is stored in the conventional QR code, the first information may have forms different from that of a conventional QR code in accordance with various embodiments of the present invention. That is, in accordance with the condition-based scheme corresponding to an embodiment of the present invention, the first information includes a plurality of pieces of data that may be provided in accordance with the relative direction information between the QR code and the QR code recognition unit 110, and thus may assume a form different from that stored in a conventional QR code.

In contrast, in accordance with the embedding scheme corresponding to another embodiment of the present invention, the first information includes one of the pieces of online link information of a blog, a cafe and a website that provide personal information, company information, tourism information, movie information, etc., like that of a conventional QR code.

3. Step of Extracting Second Information Including Relative Direction Information Between QR Code and QR Code Recognition Unit <S630>

The second information extraction unit 130 extracts second information, including the relative direction information between the QR code and the QR code recognition unit 110, from the data acquired at step S610. The second information is information that is extracted in order to provide different information in accordance with the relative direction information so that the range of usage and function of conventional QR code can be significantly improved. Of the above-described information, the relative direction information between the QR code and the QR code recognition unit 110 refers to information about the angle between the QR code and a user carrying the apparatus 100 for recognizing QR code, i.e., information that enables the location of the user to be determined based on the QR code. The relative direction information is represented using a normal vector and a direction vector.

The normal vector corresponds to an angle formed by a plane including the QR code and a plane including the camera sensor of the QR code recognition unit 110, and the direction vector corresponds to a direction in which the QR code is located on the plane including the QR code. Since a method of obtaining the vectors is the same as the method described above, a description thereof is omitted.

4. Step of Generating Decoding Data <S640>

As described above, in order to provide decoding data based on the relative direction information between the QR code and the apparatus 100 for recognizing QR code, which is calculated at step S630, the two embodiments are mainly proposed by the present invention.

These two embodiments have different configurations depending on whether a plurality of pieces of data based on the relative direction information has been encoded in the QR code.

First, the condition-based scheme is a method of obtaining corresponding information in accordance with the condition of relative direction information. In this method, conditional equations have been given to pieces of relative direction information, and a plurality of pieces of data that should be provided in accordance with the conditional equations is present. A single piece of data is present in accordance with each conditional equation, and data meeting the condition is finally selected. That is, in QR code based on the condition-based scheme, different pieces of data that are provided for respective pieces of relative direction information have been defined.

Next, the embedding scheme is a method of obtaining relative direction information in the state in which the relative direction information is included in decoding data itself. Calculated relative direction information is provided to a server. For example, in the embedding scheme, a single piece of result provision information, such as online link information, is included in a QR code.

Relative direction information, a condition, and information about a location where embedment will be performed are included in a header located in front of conventional QR code information, as shown in FIG. 4. The header and the data are distinguished by delimiter “:”. When the first letter of the header is C, it indicates that header information has been configured based on the condition-based scheme; when the first letter of the header is E, it indicates that header information has been configured based on the embedding scheme.

The step S640 of generating decoding data is described in connection with the above-described condition-based scheme and embedding scheme below.

In connection with the condition-based scheme, first information includes a plurality of pieces of data that will be provided in accordance with relative direction information. For example, a QR code includes online link information for each piece of relative direction information. The decoding data generation unit 140 selects at least part of the plurality of pieces of data, included in the first information, using the second information as a condition of selection, and generates the selected data as decoding data. That is, the decoding data generation unit 140 generates decoding data based on data matching the relative direction information between the QR code and the QR code recognition unit 110, which is extracted by the second information extraction unit 130, among data to be provided in accordance with the relative direction information, i.e., the first information extracted from the QR code by the first information extraction unit 120. The condition of selection is expressed in the form of a general equation, and is present in parallel in the header. Pieces of data corresponding to respective conditional equations are present in parallel in data.

In connection with the embedding scheme, the decoding data generation unit 140 generates decoding data including first information and second information. In other words, the decoding data generation unit 140 generates decoding data based on online link information, i.e., the first information extracted from the QR code by the first information extraction unit 120, and the relative direction information between the QR code and the QR code recognition unit 110, which is extracted by the second information extraction unit 130.

5. Step of Transmitting Generated Decoding Data and Receiving Corresponding Data <S640>

The communication unit 150 transmits the decoding data, generated at step S640 as described above, to a server, receives corresponding data from the server, and provides the received data to a user via the display unit 160.

As described above, the present invention additionally obtains information about the relative direction between a QR code and the QR code recognition unit 110, rather than simply obtaining data encoded in a QR code, and provides different information in accordance with the obtained information even in the case of the same QR code, thereby achieving the effect of providing user-customized information based on the height or direction of a user, which cannot be provided by conventional QR codes.

That is, unlike the method in which a conventional QR code provides the same information to all users simply using contained data, the present invention additionally obtains the relative direction information between a QR code and a user through calculation, and provides different information based on the relative direction information, thereby considerably improving the range of usage and function of conventional QR codes. For example, QR codes are widely used in advertising. When the present invention is applied to advertising, information about the height of a user can be obtained, and thus the effect of an advertisement can be further increased by introducing products appropriate for the height of the user via the advertisement of clothes.

Meanwhile, the method of recognizing QR code in accordance with one embodiment of the present invention may be implemented in the form of program instructions that can be executed by a variety of computer means, and may be stored in a computer-readable storage medium. The computer-readable storage medium may include program instructions, a data file and a data structure solely or in combination. The program instructions that are stored in the medium may be designed and constructed particularly for the present invention, or may be known and available to those skilled in the field of computer software. Examples of the computer-readable storage medium include magnetic media such as a hard disk, a floppy disk and a magnetic tape, optical media such as CD-ROM and a DVD, magneto-optical media such as a floptical disk, and hardware devices particularly configured to store and execute program instructions such as ROM, RAM, and flash memory. Examples of the program instructions include not only machine language code that is constructed by a compiler but also high-level language code that can be executed by a computer using an interpreter or the like. The above-described hardware components may be configured to act as one or more software modules that perform the operation of the present invention, and vice versa.

The above description is merely an illustrative description of the technical spirit of the present invention. It will be apparent to those having ordinary knowledge in the technical field to which the present invention pertains that various modifications and alterations can be made without depart from the essential characteristics of the present invention. Accordingly, the embodiments disclosed herein are not intended to limit the technical spirit of the present invention, but are intended to illustrate the technical spirit of the present invention. The scope of the technical spirit of the present invention is not limited by these embodiments. The range of protection of the present invention should be defined based on the attached claims, and all technical spirit falling within a range equivalent to the claims should be construed as being included in the range of rights of the present invention.

### INDUSTRIAL APPLICABILITY

The present invention relates to an apparatus and method for recognizing a QR code and, more particularly, to QR code recognition technology that is capable of acquiring not only primary information but also additional information about a user's context or a user from a conventional QR code and then providing user customized information, and information provision technology using the same.

For this purpose, an apparatus for recognizing a QR code in accordance with an embodiment of the present invention includes a QR code recognition unit, a first information extraction unit, and a second information extraction unit. The QR code recognition unit acquires data including a QR code. The first information extraction unit extracts first information stored in the QR code by decoding the acquired data. The second information extraction unit extracts second information, including relative direction information between the QR code and the QR code recognition unit, from the acquired data.

1. An apparatus for recognizing a QR code, comprising:
a QR code recognition unit configured to acquire data including a QR code;
a first information extraction unit configured to extract first information stored in the QR code by decoding the acquired data; and
a second information extraction unit configured to extract second information, including relative direction information between the QR code and the QR code recognition unit, from the acquired data.

2. The apparatus of claim 1, wherein:
the relative direction information between the QR code and the QR code recognition unit is represented using a normal vector and a direction vector;
the normal vector corresponds to an angle that is formed by a plane including the QR code and a plane including a camera sensor of the QR code recognition unit; and
the direction vector corresponds to a direction in which the QR code is located on the plane including the QR code.

3. The apparatus of claim 2, wherein the normal vector is calculated using Equation 1 below:
$$\vec{V} = \frac{( \vec{OC} - \vec{OA} ) \times ( \vec{OB} - \vec{OA} )}{\vert ( \vec{OC} - \vec{OA} ) \times ( \vec{OB} - \vec{OA} ) \vert} = \frac{( β \vec{{OC}^{′}} - α \vec{{OA}^{′}} ) \times ( {\vec{OB} }^{′} - α \vec{{OA}^{′}} )}{\vert ( β \vec{{OC}^{′}} - α \vec{{OA}^{′}} ) \times ( {\vec{OB} }^{′} - α \vec{{OA}^{′}} ) \vert} \qquad ( 1 )$$
\vec{V}: the normal vector
A, B and C: points corresponding to respective corners of the QR code, wherein A is (a₁, a₂, a₃), B is (b₁, b₂, b₃), and C is (c₁, c₂, c₃); and
A′, B′ and C′: points in the image, taken by the camera sensor of the QR code recognition unit, corresponding to A, B and C, wherein A′ is (d₁, d₂, d₃) B′ is (f₁, f₂, f₃), and C′ is (e₁, e₂, e₃); and
O: an origin
$$α = \frac{{a}_{3}}{{b}_{3}} , \\ β = \frac{{c}_{3}}{{b}_{3}} , \\ {b}_{3} \neq 0$$

4. The apparatus of claim 2, wherein the direction vector is calculated using Equation 2 below:
$$\vec{W} = \frac{\vec{CB}}{\vert \vec{CB} \vert} = \frac{β \vec{{OC}^{′}} - \vec{{OB}^{′}}}{\vert β \vec{{OC}^{′}} - \vec{{OB}^{′}} \vert} \qquad ( 2 )$$
\vec{W}: the direction vector
B and C: points corresponding to respective corners of the QR code, wherein B is (b₁, b₂, b₃), and C is (c₁, c₂, c₃); and
B′ and C′: points in the image, taken by the camera sensor of the QR code recognition unit, corresponding to B and C, wherein B′ is (f₁, f₂, f₃), and C′ is (e₁, e₂, e₃); and
O: an origin
$$β = \frac{{c}_{3}}{{b}_{3}} , \\ {b}_{3} \neq 0$$

5. The apparatus of claim 3, wherein the second information extraction unit approximates the normal vector and the direction vector, and the normal vector and the direction vector are calculated by Equation 3 below:
$$\vec{W} = \frac{β \vec{{OC}^{′}} - \vec{{OB}^{′}}}{\vert β \vec{{OC}^{′}} - \vec{{OB}^{′}} \vert} \sim \frac{\vec{{B}^{′} {C}^{′}}}{\vert \vec{{B}^{′} {C}^{′}} \vert} , β \sim 1 \\ \vec{{V}_{xz}} = \frac{{( \vec{{OA}^{′}} + \vec{{OB}^{′}} )}_{xz}}{\vert {( \vec{{OA}^{′}} + \vec{{OB}^{′}} )}_{xz} \vert} \\ \vec{{V}_{yz}} = \frac{{( \vec{{OA}^{′}} + \vec{{OC}^{′}} )}_{yz}}{\vert {( \vec{{OA}^{′}} + \vec{{OC}^{′}} )}_{yz} \vert} \qquad ( 3 )$$
\vec{V}_{xz}: a normal vector component of the normal vector on an x-z plane
\vec{V}_{yz}: a normal vector component of the normal vector on an y-z plane
A, B and C: points corresponding to respective corners of the QR code, wherein A is (a₁, a₂, a₃), B is (b₁, b₂, b₃), and C is (c₁, c₂, c₃); and
A′, B′ and C′: points in the image, taken by the camera sensor of the QR code recognition unit, corresponding to A, B and C, wherein A′ is (d₁, d₂, d₃), B′ is (f₁, f₂, f₃), and C′ is (e₁, e₂, e₃); and
O: an origin
$$β = \frac{{c}_{3}}{{b}_{3}} , {b}_{3} \neq 0$$

6. The apparatus of claim 1, wherein the first information comprises a plurality of pieces of data to be provided in accordance with the relative direction information;
further comprising a decoding data generation unit configured to:
select at least part of the plurality of pieces of data included in the first information by using the second information as a condition of selection; and
generate the selected data as decoding data.

7. The apparatus of claim 1, further comprising a decoding data generation unit configured to generate decoding data including the first information and the second information.

8. A method of recognizing a QR code, comprising:
(a) acquiring data including a QR code;
(b) extracting first information stored in the QR code by decoding the acquired data; and
(c) extracting second information, including relative direction information between the QR code and a QR code recognition unit, from the acquired data.

9. The method of claim 8, wherein:
the relative direction information between the QR code and the QR code recognition unit is represented using a normal vector and a direction vector;
the normal vector corresponds to an angle that is formed by a plane including the QR code and a plane including a camera sensor of the QR code recognition unit; and
the direction vector corresponds to a direction in which the QR code is located on the plane including the QR code.

10. The method of claim 9, wherein the normal vector is calculated using Equation 4 below:
$$\vec{V} = \frac{( \vec{OC} - \vec{OA} ) \times ( \vec{OB} - \vec{OA} )}{\vert ( \vec{OC} - \vec{OA} ) \times ( \vec{OB} - \vec{OA} ) \vert} = \frac{( β \vec{{OC}^{′}} - α \vec{{OA}^{′}} ) \times ( {\vec{OB} }^{′} - α \vec{{OA}^{′}} )}{\vert ( β \vec{{OC}^{′}} - α \vec{{OA}^{′}} ) \times ( {\vec{OB} }^{′} - α \vec{{OA}^{′}} ) \vert} \qquad ( 4 )$$
\vec{V}: the normal vector
A, B and C: points corresponding to respective corners of the QR code, wherein A is (a₁, a₂, a₃), B is (b₁, b₂, b₃), and C is (c₁, c₂, c₃); and
A′, B′ and C′: points in the image, taken by the camera sensor of the QR code recognition unit, corresponding to A, B and C, wherein A′ is (d₁, d₂, d₃), B′ is (f₁, f₂, f₃), and C′ is (e₁, e₂, e₃); and
O: an origin
$$α = \frac{{a}_{3}}{{b}_{3}} , \\ β = \frac{{c}_{3}}{{b}_{3}} , \\ {b}_{3} \neq 0$$

11. The method of claim 9, wherein the direction vector is calculated using Equation 5 below:
$$\vec{W} = \frac{\vec{CB}}{\vert \vec{CB} \vert} = \frac{β \vec{{OC}^{′}} - \vec{{OB}^{′}}}{\vert β \vec{ {OC}^{′}} - \vec{{OB}^{′}} \vert} \qquad ( 5 )$$
\vec{W}: the direction vector
B and C: points corresponding to respective corners of the QR code, wherein B is (b₁, b₂, b₃), and C is (c₁, c₂, c₃); and
B′ and C′: points in the image, taken by the camera sensor of the QR code recognition unit, corresponding to B and C, wherein B′ is (f₁, f₂, f₃), and C′ is (e₁, e₂, e₃); and
O: an origin
$$β = \frac{{c}_{3}}{{b}_{3}} , \\ {b}_{3} \neq 0$$

12. The method of claim 9, wherein step (c) comprises approximating the normal vector and the direction vector, and calculating the normal vector and the direction vector by Equation 6 below:
$$\vec{W} = \frac{β \vec{{OC}^{′}} - \vec{{OB}^{′}}}{\vert β \vec{ {OC}^{′}} - \vec{{OB}^{′}} \vert} ∼ \frac{\vec{{B}^{′} {C}^{′}}}{\vert \vec{{B}^{′} {C}^{′}} \vert} , β \sim 1 \\ \vec{{V}_{xz}} = \frac{{( \vec{{OA}^{′}} + \vec{{OB}^{′}} )}_{xz}}{\vert {( \vec{{OA}^{′}} + \vec{{OB}^{′}} )}_{xz} \vert} \\ \vec{{V}_{yz}} = \frac{{( \vec{{OA}^{′}} + \vec{{OC}^{′}} )}_{yz}}{\vert {( \vec{{OA}^{′}} + \vec{{OC}^{′}} )}_{yz} \vert} \qquad ( 6 )$$
\vec{V}_{xz}: a normal vector component of the normal vector on an x-z plane
\vec{V}_{yz}: a normal vector component of the normal vector on an y-z plane
A, B and C: points corresponding to respective corners of the QR code, wherein A is (a₁, a₂, a₃), B is (b₁, b₂, b₃), and C is (c₁, c₂, c₃); and
A′, B′ and C′: points in the image, taken by the camera sensor of the QR code recognition unit, corresponding to A, B and C, wherein A′ is (d₁, d₂, d₃), B′ is (f₁, f₂, f₃), and C′ is (e₁, e₂, e₃); and
O: an origin
$$β = \frac{{c}_{3}}{{b}_{3}} , \\ {b}_{3} \neq 0$$

13. The method of claim 8, wherein the first information comprises a plurality of pieces of data to be provided in accordance with the relative direction information;
further comprising selecting at least part of the plurality of pieces of data included in the first information by using the second information as a condition of selection, and generating the selected data as decoding data.

14. The method of claim 8, further comprising generating decoding data including the first information and the second information.

15. A computer-readable storage medium having stored therein a program for executing the method set forth in claim 8.
